(19) United States
(12) Patent Application Publication
(10) Pub. No.: US 2008/0286674 A1
(43) Pub. Date: Nov. 20, 2008

(54) Toner and Method for Producing the Same

(75) Inventors: Masateru Kawamura, Toyoake-shi (JP); Jun Ikami, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/122,010

(22) Filed: May 16, 2008

(30) Foreign Application Priority Data
May 16, 2007 (JP) 2007-130783

(51) Int. Cl. G03G 9/087

(52) U.S. Cl. 430/105; 430/137.14

(57) ABSTRACT

A method for producing a toner is described. The method for producing a toner may include the steps of: preparing a resin solution by mixing a binder resin, a colorant and a wax into an organic solvent; preparing an emulsion by heating the resin solution and an aqueous medium to a temperature of not less than a level allowing the wax to dissolve and less than the boiling point of the organic solvent, and mixing the resin solution and the aqueous medium with each other; and preparing a suspension by removing the organic solvent from the emulsion, and aggregating and fusing the suspension.

### CROSS REFERENCE TO RELATED APPLICATION

The present application claims priority to Japanese Patent Application No. 2007-130783, filed on May 16, 2007, the disclosure of which is hereby incorporated into the present application by reference.

### TECHNICAL FIELD

The present invention relates to a toner employed in electrophotography, electrostatic recording and the like and a method for producing the toner.

### BACKGROUND

As a conventional method for producing a toner, an emulsion dispersion method for obtaining toner particles by mixing a mixture of a binder resin and a colorant with an aqueous medium and emulsifying the resulting mixture is known.

The emulsion dispersion method has such advantages that the toner can be easily reduced in diameter or rendered spherical, that the range of alternatives to the type of the binder resin is widened as compared with the polymerization method, that the quantities of residual monomers can be easily reduced, and that the concentration of the colorant or the like can be arbitrarily changed.

For example, a resin solution is prepared by heating a mixture containing polyester resin, a colorant and a releasing agent to a temperature of not less than the softening point of the polyester resin and not more than the thermal decomposition temperature thereof, kneading the mixture, and thereafter dispersing the resulting kneaded chip in an organic solvent. Then, the resin solution is mixed with an aqueous medium and emulsified under the presence of a basic neutralizer. Thereafter the organic solvent is removed, microparticles are aggregated, and an aggregate of the microparticles is formed by fusion, thereby obtaining toner particles.

It is also proposed a method for obtaining toner particles by preparing slurry of polyester resin, separately producing a colorant dispersion and a releasing agent dispersion, adding these dispersions to the slurry, and thereafter aggregating and fusing the mixture.

In the former method, however, the mixture must be heated at a high temperature with a large amount of energy when kneaded, and hence the producing cost is inevitably increased. In the latter method, the materials must be refined with a dispersing apparatus such as a bead mill with a large amount of energy in order to prepare the dispersions, and hence the producing cost is inevitably increased. Further, the number of the producing steps is increased in either case, and the producing cost is inevitably increased also in this point.

If the releasing agent is insufficiently kneaded in the former method or insufficiently refined in the latter method, on the other hand, the releasing agent is not uniformly dispersed in the resin particles, to result in reduction in fixability or to result in filming.

### SUMMARY

One aspect of the present invention may provide a method for producing a toner capable of uniformly dispersing a wax in resin particles easily at a low cost, and a toner obtained by this method.

The same or different aspect of the present invention may provide a method for producing a toner including the steps of: preparing a resin solution by mixing a binder resin, a colorant and a wax into an organic solvent; preparing an emulsion by heating the resin solution to a temperature of not less than a level allowing the wax to dissolve and less than a boiling point of the organic solvent while heating an aqueous medium to the temperature, and mixing the resin solution and the aqueous medium with each other; and preparing a suspension by removing the organic solvent from the emulsion, and aggregating and fusing the suspension.

One or more aspect of the present invention provide a toner obtained by a method for producing a toner including the steps of: preparing a resin solution by mixing a binder resin, a colorant and a wax into an organic solvent; preparing an emulsion by heating the resin solution to a temperature of not less than a level allowing the wax to dissolve and less than a boiling point of the organic solvent while heating an aqueous medium to the temperature, and mixing the resin solution and the aqueous medium with each other; and preparing a suspension by removing the organic solvent from the emulsion, and aggregating and fusing the suspension.

### DETAILED DESCRIPTION

An embodiment of a method for producing a toner according to the present invention is now described.

### 1) Step of Preparing Resin Solution

According to this method, a resin solution is first prepared by mixing a binder resin, a colorant and a wax into an organic solvent.

### (Binder Resin)

The binder resin is a main component of the toner and is made of a synthetic resin which fixes (heat-seals) on the surface of a recording medium (paper, an OHP sheet, etc.) by heating and/or pressurizing.

No particular limitation is imposed on the type of the binder resin. A known synthetic resin which is known as a binder resin for toners may be employed. Examples of the binder resin include polyester resin, styrene resin (e.g., styrene such as polystyrene, poly-p-chlorostyrene and polyvinyltoluene, or its derivative; e.g., styrene-styrene derivative copolymers such as styrene-p-chlorostyrene copolymer and styrene-vinyltoluene copolymer; e.g., styrene copolymers such as styrene-vinylnaphthalene copolymer, styrene-acrylic acid-based copolymer, styrene-methacrylic acid-based copolymer, styrene-methyl a-chloromethacrylate copolymer, styrene-acrylonitrile copolymer, styrene-vinyl methyl ether copolymer, styrene-vinyl ethyl ether copolymer, styrene-vinyl methyl ketone copolymer, styrene-butadiene copolymer, styrene-isoprene copolymer, and styrene-acrylonitrile-indene copolymer), and other resins such as acrylic resin, methacrylic resin, polyvinyl chloride resin, phenolic resin, naturally modified phenolic resin, natural resin-modified maleic acid resin, polyvinyl acetate resin, silicone resin, polyurethane resin, polyamide resin, furan resin, epoxy resin, polyvinyl butyral resin, terpene resin, coumarone-indene resin, and petroleum resin. These resins can be used alone or in combination.

The binder resin preferably has a hydrophilic group. If the binder resin has a hydrophilic group, no surfactant may be mixed for preparing the emulsion. Examples of the hydrophilic group include cationic groups such as a quaternary ammonium group, a quaternary ammonium salt-containing group, an amino group and a phosphonium salt-containing group; and anionic groups such as a carboxyl group and a sulfonic acid group.

The binder resin is preferably binder resin having an anionic group, more preferably polyester resin having an anionic group, particularly preferably polyester resin having a carboxyl group (polyester resin having an acid value).

The aforementioned polyester resin having a carboxyl group is on the market, and polyester resin having an acid value of 0.5 to 40 mgKOH/g, more preferably 1.0 to 20 mgKOH/g, a weight-average molecular weight (according to GPC measurement with a calibration curve of standard polystyrene) of 9,000 to 200,000, preferably 20,000 to 150,000, and a crosslinking content (THF insoluble) of not more than 10 percent by weight, preferably 0.5 to 10 percent by weight is employed, for example.

If the acid value is lower than this range, the amount of reaction with a base such as sodium hydroxide added later may be small so that stable slurry cannot be obtained due to instable emulsion. If the acid value is higher than this range, on the other hand, the chargeability of the toner may be excessively increased to result in reduction of image density or the like.

If the weight-average molecular weight is lower than this range, the mechanical strength of the toner may be insufficient, so that the durability of the toner is reduced. If the weight-average molecular weight is higher than this range, on the other hand, the melt viscosity of the toner may be excessively increased, so that the emulsified droplets are increased in size to result in easy formation of coarse particles.

Although the toner may contain absolutely no crosslinking content, a certain amount of crosslinking content is preferably present therein, in order to improve the strength and fixability (particularly offset on the high-temperature side) of the toner. If the amount of the crosslinking content is excessively large, however, the emulsified droplets may be increased in size to result in formation of coarse particles.

### (Colorant)

The colorant is a substance for imparting a desired color to the toner, and is incorporated into the binder resin through dispersion or permeation. Examples of the colorant include carbon black; organic pigments such as Quinophthalone Yellow, Hansa Yellow, Isoindolinone Yellow, Benzidine Yellow, Perynone Orange, Perynone Red, Perylene Maroon, Rhodamine 6G Lake, Quinacridone Red, Rose Bengal, Copper Phthalocyanine Blue, Copper Phthalocyanine Green, and a diketopyrrolopyrole pigment; inorganic pigments and metal powders such as Titanium White, Titanium Yellow, ultramarine, Cobalt Blue, red iron oxide, aluminum powder, and bronze; oil-soluble dyes and dispersion dyes such as azo dyes, quinophthalone dyes, anthraquinone dyes, xanthene dyes, triphenylmethane dyes, phthalocyanine dyes, indophenol dyes, and indoaniline dyes: and rosin dyes such as rosin, rosin-modified phenol, and rosin-modified maleic acid resin. Further, other dyes and pigments treated with higher fatty acid or resin may be used.

These can be used alone or in combination corresponding to a desired color. For example, when a mono-chromatic color toner is provided, the colorant can be prepared by mixing a pigment and a dye of the same color, such as rhodamine pigment and dye, quinophthalone pigment and dye, or phthalocyanine pigment and dye.

The colorant is mixed at a ratio of, for example, 2 to 20 parts by weight, or preferably 4 to 10 parts by weight, based on 100 parts by weight of the binder resin.

### (Wax)

The wax is added in order to improve the fixability of the toner to a recording medium. In the case of thermal pressure fixation, the toner generally encapsulates the wax so as to be easily separated from a heating medium. The wax may be ester wax or hydrocarbon wax, for example.

Examples of the ester wax include aliphatic ester compounds such as stearate ester and palmitate ester; and polyfunctional ester compounds such as pentaerythritol tetramyristate, pentaerythritol tetrapalmitate and dipentaerythritol hexapalmitate.

Examples of the hydrocarbon wax include polyolefin waxes such as low-molecular weight polyethylene, low-molecular weight polypropylene, and low-molecular weight polybutylene; plant-derived natural waxes such as candelilla wax, carnauba wax, rice wax, Japan wax, and Jojoba wax; petroleum waxes such as paraffin wax, microcrystalline and petrolatum, and modified waxes thereof: synthetic waxes such as Fischer-Tropsch wax.

These waxes can be used alone or in combination. A wax having a melting point of 50 to 100° C. is preferable among the aforementioned waxes. The wax having a low melting point and a low melt viscosity is melted in advance of the binder resin to exude onto the surface of the toner, thereby preventing an offset, even if the heating temperature of a fixing apparatus is low. More specifically, the ester wax or the paraffin wax is selected.

The wax is mixed at a ratio of 1 to 30 parts by weight, for example, preferably 3 to 15 parts by weight, based on 100 parts by weight of the binder resin.

### (Organic Solvent)

The organic solvent is not particularly limited so far as the same can dissolve the wax at a temperature less than the boiling point thereof, but preferably exhibits a certain extent of water solubility in order to accelerate emulsion of the binder resin. Particularly in the method according to the present invention, no dispersant such as a surfactant is preferably used for stabilizing the emulsion of the resin solution. However, the hydrophilic group of the binder resin must be neutralized. If a completely hydrophobic solvent is employed, therefore, it is difficult to stabilize the emulsion since neutralization does not progress. Thus, the solvent preferably has a certain degree of water solubility.

For such an organic solvent, the organic solvent is preferably capable of compatibility by 5 to 100% in water of 25° C. More specifically, examples of the organic solvent include esters such as ethyl acetate and butyl acetate; glycols such as ethylene glycol, diethylene glycol, ethylene glycol monomethyl ether and diethylene glycol monomethyl ether; ketones such as acetone, methyl ethyl ketone (MEK) and methyl isobutyl ketone; and ether such as tetrahydrofuran (THF). These organic solvents can be used alone or in combination.

Preferably, an organic solvent having a boiling point of 50 to 100° C., more preferably 60 to 90° C., is selected. More specifically, methyl ethyl ketone (boiling point: 79.6° C. at normal pressure (1 atm)) or tetrahydrofuran (boiling point: 65° C. at normal pressure) can be selected.

The organic solvent is mixed at a ratio of 100 to 2000 parts by weight, for example, preferably 200 to 1000 parts by weight, based on 100 parts by weight of the binder resin.

### (Preparation of Resin Solution)

In preparation of the resin solution, the binder resin, the colorant and the wax are mixed into the organic solvent at the aforementioned ratios. In this mixing step, the respective components are mixed with one another and dispersed, and the mixture is thereafter heated to a temperature of not less than a level allowing the wax to dissolve and less than the boiling point of the organic solvent. More specifically, the mixture is heated to a temperature exceeding 30° C., for example, preferably to 32 to 79° C., more preferably to 35 to 75° C. when MEK is employed, or to 32 to 60° C. when THF is employed, depending on the types of the wax and the organic solvent, to dissolve the wax in the organic solvent. Thus, the resin solution is prepared.

### 2) Step of Preparing Emulsion

According to this method, the aqueous medium is heated to the temperature of not less than the level allowing the wax to dissolve and less than the boiling point of the organic solvent, and the resin solution kept at the aforementioned temperature is mixed into this aqueous medium, to prepare the emulsion.

### (Aqueous Medium)

The aqueous medium may be, for example, water or a water medium mainly composed of water and mixed with some water-soluble solvent (alcohol, for example) or additive (a surfactant or a dispersant, for example). Further, the aqueous medium is prepared as an aqueous alkaline solution when a binder resin having an anionic group is employed, for example. Examples of the aqueous alkaline solution include an aqueous organic base solution prepared by dissolving a basic organic compound such as amine in water, and an aqueous inorganic base solution prepared by dissolving an alkaline metal such as sodium hydroxide or potassium hydroxide in water.

The aqueous inorganic base solution is prepared as aqueous sodium hydroxide solution or aqueous potassium hydroxide solution of 0.1 to 5 N (normal), for example, preferably 0.2 to 2 N (normal). If a wax hardly dissolvable in a resin solution due to the inclusion of water is mixed, an aqueous organic base solution is preferably employed in order to prevent deposition of the wax.

### (Preparation of Emulsion)

In order to prepare the emulsion, the resin solution and the aqueous medium are mixed with each other at a ratio of 50 to 150 parts by weight, for example, preferably 80 to 120 parts by weight, of the resin solution based on 100 parts by weight of the aqueous medium, while keeping both of the resin solution and the aqueous medium at the temperature of not less than the level allowing the wax to dissolve and less than the boiling point of the organic solvent.

The resin solution and the aqueous medium may be heated to the same temperature so far as the temperature is not less than the level allowing the wax to dissolve and less than the boiling point of the organic solvent, or can be heated to different temperatures.

Thereafter the aqueous medium mixed with the resin solution is stirred while keeping the aforementioned heating temperature. The mixture may be stirred by a stirrer such as a three-one motor with a turbine blade or a propeller blade, for example. In order to further reduce the sizes of emulsified droplets, a high-speed dispersing apparatus such as a homogenizer is preferably used. Alternatively, a dispersing apparatus such as a high-pressure homogenizer may be used. If a rotor-stator type stirrer such as a homogenizer is employed, the mixture is stirred at a tip circumferential velocity of 5 to 20 m/s, preferably 7 to 14 m/s, for 10 to 120 minutes, more preferably for 15 to 60 minutes. Thus, the resin solution forms droplets of 100 to 1000 nm and emulsified in the aqueous medium, to provide the emulsion.

In this emulsion step, the wax is melted in the organic solvent, whereby the relatively hydrophilic binder resin is exposed toward the aqueous medium while the relatively hydrophobic wax is present inside the droplets. Therefore, the wax can be uniformly introduced into resin microparticles in the subsequent steps.

If the heating temperature for the aqueous medium in the emulsion step is lower than the level allowing the wax to dissolve, the wax is deposited and exposed from the droplets or coarse particles (having a deposited wax particle size of 10 to 1000 μm, for example) are formed when the resin solution and the aqueous medium are mixed with each other. If the heating temperature for the aqueous medium is in excess of the boiling point of the organic solvent, on the other hand, the organic solvent is evaporated after the resin solution and the aqueous medium are mixed with each other, to cause defective emulsion.

In order to prepare the emulsion, the resin solution may be mixed into the aqueous medium, or the aqueous medium may be mixed into the resin solution. When a binder resin having an anionic group is employed, an aqueous alkaline solution may be previously mixed into the resin solution to neutralize the same and then water is mixed thereto, or water can be mixed to a previously neutralized resin solution.

In order to prevent deposition of the wax, the aqueous medium is preferably mixed into the resin solution. If a binder resin having an anionic group is employed, preferably, an aqueous alkaline solution is previously mixed into the resin solution to neutralize the same, and then water is mixed thereto.

### 3) Step of Preparing Suspension

According to this method, the organic solvent is removed from the emulsion to obtain a suspension. To remove the organic solvent from the emulsion, a known method such as ventilation, heating, decompression, or combination thereof is employed. For example, the emulsion is heated under inert gas atmosphere, for example, at a temperature of room temperature to 90° C., or preferably 65 to 80° C., until about 80 to 95% by weight of the initial amount of the organic solvent is removed. As a result, the organic solvent is removed from the aqueous medium, so that a suspension (slurry) having resin microparticles of the binder resin in which the colorant and the wax are uniformly dispersed is prepared.

The solid concentration of the obtained suspension (the concentration of the resin particles in the suspension) is 5 to 50 percent by weight, for example, preferably 10 to 30 percent by weight. The volume-average particle size of the resin microparticles dispersed in the aqueous medium is 30 to 1000 nm, for example, preferably 50 to 500 nm, as a median size.

The suspension is further diluted with the aqueous medium, so that the solid concentration thereof is 1 to 30 percent by weight, for example, preferably 5 to 20 percent by weight.

### 4) Step of Aggregation/Melting

According to this method, the resin microparticles are aggregated by adding a aggregator to the suspension and the aggregated resin microparticles are fused (melted) by heating, thereby growing the particle size of the resin microparticles and obtaining toner base particles.

Examples of the aggregator include inorganic metallic salt such as calcium nitrate and a polymer of inorganic metallic salt such as polyaluminum chloride.

In the aggregation step, an aqueous solution of the aggregator adjusted to 0.01 to 1.0 N (normal), for example, preferably 0.05 to 0.5 N (normal), is added at a ratio of 0.1 to 10 parts by weight, for example, preferably 0.5 to 5 parts by weight, based on 100 parts of the suspension, and the mixture is stirred.

While the method of stirring is not particularly limited, the suspension is dispersed by a high-speed dispersing apparatus such as a homogenizer, for example, and the components are mixed with one another by a stirrer with a mixing blade, to entirely fluidize the suspension. As the mixing blade, a well-known blade such as a flat turbine blade, a propeller blade or an anchor blade is employed. Alternatively, the suspension can be stirred with an ultrasonic dispersing apparatus. The liquid temperature in the stirring step is 10 to 50° C., for example, preferably 20 to 30° C., and the stirring time is 5 to 60 minutes, for example, preferably 10 to 30 minutes.

Thereafter the suspension is preferably heated to homogenize the aggregated state. The suspension is heated to a temperature of 35 to 60° C., for example, so as not to fuse the particles. Thereafter the aggregation step is terminated by adding an aggregation terminator, and the aggregated resin micropartlcles are fused by heating.

Examples of the aggregation terminator include alkaline metals such as sodium hydroxide and potassium hydroxide. An ionic surfactant may also be employed.

When adding the aggregation terminator, an aqueous alkaline metal solution adjusted to 0.01 to 5.0 N (normal), for example, preferably 0.1 to 2.0 N (normal), is added at a ratio of 0.5 to 20 parts by weight, for example, preferably 1.0 to 10 parts by weight, based on 100 parts of the suspension, and the suspension is continuously stirred.

In order to fuse the resin microparticles, the suspension is thereafter heated at a temperature of not less than the glass transition temperature (Tg) of the resin while continuously stirring the suspension. More specifically, the suspension is heated at 55 to 100° C., for example, preferably to 65 to 95° C. The suspension may be heated for 0.5 to 10 hours, for example, until the resin microparticles are fused into a desired shape, depending on the type of the resin. Irregular-shaped toner base particles can be obtained by reducing the heating time, while spherical base particles can be obtaining by further continuously heating the suspension. Thus, the aggregated resin microparticles are fused to form toner base particles having a volume-average particle size of 3 to 12 μm, for example, preferably 6 to 10 μm.

Thereafter the toner base particles are cooled, back-neutralized with acid, thereafter filtrated and dried to obtain powder of the toner base particles.

When back-neutralizing the toner base particles, an aqueous solution of 0.01 to 5 N (normal), for example, preferably 0.1 to 2 N (normal), is prepared from inorganic acid such as hydrochloric acid, sulfuric acid or nitric acid, for example, and added at a ratio of 0.05 to 2 parts by weight, for example, preferably 0.1 to 1 part by weight, based on 100 parts by weight of the suspension, and the mixture is thereafter stirred for 10 to 180 minutes, preferably for 15 to 120 minutes, to fluidize the suspension.

### 5) Mixing of Additive

A charge controller and an external additive are added to the obtained toner base particles if necessary, to obtain a desired toner.

### (Addition of Charge Controller)

A positively chargeable charge controller and/or a negatively chargeable charge controller is used alone or in combination, in response to the object and application.

Examples of the positively chargeable charge controller include a nigrosine dye, a quaternary ammonium compound, an onium compound, a triphenylmethane compound, a basic group-containing compound and tertiary amino group-containing acrylic resin,

Examples of the negatively chargeable charge controller include a trimethylethane dye, an azo pigment, copper phthalocyanine, salicylic acid metal complex, benzylic acid metal complex, perylene, quinacridone and a metal complex azo dye.

When adding the charge controller, for example, a dispersion of the charge controller is mixed to the toner base particles and the mixture is stirred, thereafter filtrated and dried so that the charge controller is fixed to the toner base particles. The dispersion of the charge controller is prepared as a dispersion containing 5 to 20 percent by weight of the charge controller, for example. The dispersion of the charge controller is added at a ratio of 0.1 to 10 parts by weight, for example, preferably 0.5 to 5 parts by weight, based on 100 parts by weight of the toner base particles.

The dispersion of the charge controller may be prepared by either of a mechanical method or a chemical method. For example, the charge controller may be dispersed in water, and be forcedly refined and dispersed with an apparatus which can apply high shear force, such as a homogenizer, a high-pressure homogenizer or a bead mill. Further, when the charge controller is a polymer, the suspension polymerization method, the emulsion dispersion method or the dispersion polymerization method may be employed. Further, a method, in which a water dispersion is obtained by dissolving or swelling a polymer-based charge controller in an organic solvent to be mixedly emulsified with water and removing the organic solvent from the resulting emulsion through heating and pressure reduction or the like, may be employed. The dispersed particle diameter of the charge controller (median size based on volume) is preferably 50 to 300 nm, and particularly preferably 100 to 200 nm. If the diameter is smaller than the above range, the charge may become excessively high and cause a problem such as reduction in image density. If the diameter is higher than the above range, the charge may become excessively low and cause deterioration of an image such as fog.

Thus, the charge controller is fixed at a ratio of 0.01 to 5 parts by weight, for example, preferably 0.05 to 3 parts by weight, based on 100 parts by weight of the toner base particles.

### (Addition of External Additive(s))

The external additive is added in order to adjust charging characteristics, flowability, storage stability, etc., of the toner, and is in the form of ultra-microparticles considerably smaller than the toner base particles.

Examples of the external additive include inorganic particles and synthetic resin particles.

Examples of the inorganic particles include silica, aluminum oxide, titanium oxide, silicon aluminium cooxide, silicon titanium cooxide, and a hydrophobicized product thereof. For example, a hydrophobicized product of silica can be obtained under hydrophobicizing treatment of silica micropowder using silicone oil or a silane coupling agent (e.g., dichlorodimethylsilane, hexamethyldisilazane, tetramethyldisilazane, etc.).

Examples of the synthetic resin particles include methacrylate ester polymer particles, acrylic ester polymer particles, styrene-methacrylate ester copolymer particles. styrene-acrylate ester copolymer particles, and core-shell particles (core: styrene polymer, shell: methacrylate ester polymer).

When adding the external additive, the toner base particles and the external additive are mixed and stirred with a high-speed stirrer such as a Henschel mixer, for example. The external additive is generally added at a ratio of 0.1 to 6 parts by weight based on 100 parts by weight of the toner base particles, for example.

### 6) Toner

The toner obtained in the aforementioned manner is a positively chargeable or negatively chargeable nonmagnetic one-component toner having a volume-average particle size of 3 to 12 μm, for example, preferably 6 to 10 μm, as a median size.

According to the aforementioned method, both of the resin solution and the aqueous medium are heated to the temperature of not less than the level allowing the wax to dissolve and less than the boiling point of the organic solvent and mixed with each other, whereby the wax is uniformly introduced into the resin microparticles after the emulsion step. When the resin microparticles are aggregated and fused by heating to form a toner, therefore, a toner which has excellent fixability and filming resistance and which the wax is uniformly dispersed in can be obtained.

According to this method, the resin solution and the aqueous medium are simply heated at a relatively low temperature and mixed with each other, whereby the toner can be easily produced at a low cost without requiring a large amount of energy.

### EXAMPLES

The above method for producing a toner will now be more particularly described by reference to the following examples and comparative examples. In the following description, the units “part(s)” and “%” are by weight, unless otherwise noted.

Respective physical properties were measured by the following methods: Volume-average particle size of the resin microparticles in the suspension: A Microtrac particle size analyzer (UPA150; produced by Nikkiso Co., Ltd.) was used. Pure water was employed as dilution solvent. The refractive index of the solvent and that of the dispersion were set to 1.33 and 1.9 respectively, and the same sample was then measured 3 times to thereby obtain the average value as an average median size.

Volume-average particle size of the toner: Coulter Multisizer II (produced by Beckman Coulter, Inc.: aperture diameter: 100 μm) was used.

### Examples 1 to 7

### (Preparation of Resin Solution)

In each of Examples 1 to 7, 20 parts of polyester resin FC1565 (Tg: 64° C.; Mn (number-average molecular weight): 5000; Mw (weight-average molecular weight): 98000; gel content (THF insoluble): 1.5 wt. %; acid value: 6.1 mgKOH/g; produced by Mitsubishi Rayon Co., Ltd.), 1 part of carbon black #260 (produced by Mitsubishi Chemical Corporation), and each wax of part and type shown in Table 1 were mixed to 80 parts of each organic solvent shown in Table 1, to dissolve the polyester resin in the organic solvent. Thereafter the mixture was heated to each resin solution temperature shown in Table 1 to dissolve the wax in the organic solvent, thereby preparing a resin solution.

### (Preparation of Aqueous Medium)

Separately, 100 parts of distilled water and 1 part of one normal aqueous sodium hydroxide were mixed with each other to prepare an aqueous medium, which in turn was heated to each aqueous medium temperature shown in Table 1.

### (Preparation of Emulsion)

100 parts of the resin solution and 100 parts of the aqueous medium were mixed with each other while kept at the aforementioned temperature, and the mixture was thereafter stirred with a homogenizer DIAX 900 (produced by Heidolph Japan) at 16000 rpm for 30 minutes, to prepare an emulsion.

### (Preparation of Suspension)

1600 parts of the obtained emulsion was introduced into a 2 L separable flask and heated with stirring at 70° C. for 150 minutes to remove the organic solvent while blowing nitrogen into the gas phase, thereby obtaining a suspension.

Table 1 shows the volume-average size (median size) of the resin microparticles in each suspension. The presence or absence of a deposit in each suspension was confirmed with an optical microscope. Table 1 shows the results.

Thereafter the suspension was diluted with distilled water so that the solid concentration was 10%, thereby preparing 1600 parts of the suspension.

### (Aggregation/Fusion)

Then, 2.5 parts of 0.2 normal aluminum chloride was added to 100 parts of the suspension and mixed with the suspension by a homogenizer at a high speed for 10 minutes. The suspension was thereafter stirred with six flat turbine blades at 300 rpm, heated to a liquid temperature of 45° C., and continuously stirred for 20 minutes.

Thereafter 2.5 parts of 0.2 normal aqueous sodium hydroxide solution was added to the suspension, and the mixture was heated to a liquid temperature of 90° C. The mixture was continuously stirred for about 5 hours until the toner base particles were spherical, and thereafter cooled. After the cooling, 2.5 parts of one normal aqueous hydrochloric acid solution was added to 100 parts of the suspension, and the mixture was stirred for 1 hour to fluidize the suspension, thereafter filtrated and dispersed again in water, to prepare a suspension having a solid concentration of 10 percent by weight.

### (Preparation of Dispersion of Charge Controller)

An emulsion was prepared by mixing 20 parts of a charge controller (FCA201PS: produced by Fujikura Kasei Co., Ltd.), 80 parts of MEK and 100 parts of distilled water and stirring the resulting mixture with a homogenizer at 16000 rpm for 30 minutes. Thereafter the obtained emulsion was heated to 60° C. while being stirred by a meniscoid-form impeller at 170 rpm, to remove the organic solvent through evaporation by continuously stirring the emulsion for 4 hours. The obtained dispersion of the charge controller had a solid concentration of 20 percent by weight. The dispersed particle diameter of the charge controller (median size based on volume) was 110 nm.

### (Addition of Additive)

5 parts of the obtained dispersion of the charge controller and 1000 parts of the base particle suspension were mixed with each other. Then, the mixture was stirred at 57° C. for 30 minutes and thereafter filtrated and dried, to fix the charge controller to the toner base particles.

Further, 2.0 parts of silica was mixed to 100 parts of the obtained toner base particles, and the mixture was stirred with a Henschel mixer, to obtain a positively chargeable nonmagnetic one-component toner. Table 1 shows the volume-average particle size (median size) of each obtained toner.

Table 1 also shows the content of the wax in the obtained toner.

### Comparative Example 1

A suspension was obtained in the same manner as in Example 1, except that the aqueous medium temperature was set to 25° C. According to this method, visually observable coarse particles were formed when MEK was removed from an emulsion.

Then, the coarse particles were removed through a sieve having an aperture of 250 μm, and a positively chargeable nonmagnetic one-component toner was prepared from the obtained suspension, in the same manner as in Example 1. Table 1 also shows conditions and measured values of comparative example 1, as in the case of Examples 1 to 7. It was confirmed by DSC measurement that the coarse particles contained a large amount of wax. The measurement was performed as follows:

Measurement method: 5.0 mg of the coarse particles were introduced into a sample container, and heated from a temperature of −10° C. to a temperature of 170° C. at a rising rate of 10° C./min (1st run). Then, the heated sample was rapidly cooled to −10° C. at a rate of 50° C./min, and heated from −10° C. to 170° C. at the rate of 10° C./min again (2^{nd} run), and then the endothermic amount (transition of heat) was measured. The DSC of the used wax was previously measured under the same conditions, and the content of the wax in the coarse particles was calculated on the basis of the endothermic amount.

### Comparative Example 2

A suspension was obtained in the same manner as in Example 2, except that 1 part of wax was used, that the resin solution temperature was set to 65° C. and that the aqueous medium temperature was set to 40° C. When this suspension was observed with an optical microscope, coarse particles of 1 to 20 μm were confirmed.

Then, the coarse particles were filtrated, and a positively chargeable nonmagnetic one-component toner was prepared from the suspension, in the same manner as in Example 2. Table 1 also shows conditions and measured values of comparative example 2, as in the case of Examples 1 to 7.

### Comparative Example 3

A suspension was obtained in the same manner as in Example 7, except that the aqueous medium temperature was set to 30° C. When this suspension was observed with an optical microscope, coarse particles of 1 to 20 μm were confirmed.

Then, the coarse particles were filtrated, and a positively chargeable nonmagnetic one-component toner was prepared from the suspension, in the same manner as in Example 7. Table 1 also shows conditions and measured values of comparative example 3, as in the case of Examples 1 to 7.

### Comparative Example 4

A suspension was obtained in the same manner as in Example 1, except that THF was used as the organic solvent, that the resin solution temperature was set to 20° C. and that the aqueous medium temperature was set to 30° C. When this suspension was observed with an optical microscope, coarse particles of 1 to 20 μm were confirmed.

Then, the coarse particles were filtrated, and a positively chargeable nonmagnetic one-component toner was prepared from the suspension, in the same manner as in Example 1. Table 1 also shows conditions and measured values of comparative example 4, as in the case of Examples 1 to 7.

### Evaluation of Toner

A laser printer, HL-1850 manufactured by Brother Industries, Ltd., was used to evaluate non-offset regions and drum filming of the toners obtained according to Examples 1 to 7 and comparative examples 1 to 4. Table 1 also shows the results.

### (Non-Offset Region)

The temperature of a fixing apparatus was changed from 110° C to 230° C. by 10° C. at a time, and a solid patch pattern of 13 cm square on five sheets was continuously printed. Whether or not the printed portions caused offsets after the second rotation of a heat roller was visually evaluated. Temperature regions causing no offsets were evaluated as non-offset regions.

### (Drum Filming)

After performing durable printing on 400 letter-size plain sheets with a printing area ratio of 1%, the state of a photosensitive drum was visually observed to determine the presence or absence of filming.

TABLE 1

| | | | | Wax | | | | | Volume- | | |
|---|---|---|---|---|---|---|---|---|---|---|---|
| | | | Mixed | Content | | | | Presence/ | Average | | Presence/ |
| Example/ | | | Amount | in | Resin | Aqueous | Volume-Average | Absence | Particle | | Absence |
| Comparative | Organic | | of Wax | Toner | Solution | Medium | Size of Resin | of | Size | Non-Offset | of |
| Example | Solvent | Wax | (Part) | (%) | Temperature | Temperature | Microparticles | Deposit | of Toner | Region | Filming |
| Example 1 | MEK | H476 | 1 | 5 | 45° C. | 45° C. | 256 nm | no | 8.5 μm | 140-210° C. | no |
| Example 2 | MEK | WEP3 | 1.25 | 7 | 60° C. | 60° C. | 282 nm | no | 8.7 μm | 130-220° C. | no |
| Example 3 | MEK | WEP5 | 2 | 10 | 65° C. | 65° C. | 310 nm | no | 9.0 μm | 140-230° C. | no |
| Example 4 | MEK | HNP-9 | 1 | 5 | 65° C. | 65° C. | 330 nm | no | 8.4 μm | 140-210° C. | no |
| Example 5 | MEK | SP0 | 1 | 5 | 65° C. | 65° C. | 325 nm | no | 8.7 μm | 140-210° C. | no |
| | | 160 | | | | | | | | | |
| Example 6 | THF | HNP-9 | 1 | 5 | 45° C. | 45° C. | 350 nm | no | 8.9 μm | 140-210° C. | no |
| Example 7 | THF | SP0 | 1 | 5 | 45° C. | 45° C. | 339 nm | no | 9.1 μm | 140-210° C. | no |
| | | 160 | | | | | | | | | |
| Comparative | MEK | H476 | 1 | 5 | 45° C. | 25° C. | 1500 nm | yes | 9.5 μm | 170-180° C. | yes |
| Example 1 | | | | | | | | | | | |
| Comparative | MEK | WEP3 | 1 | 5 | 65° C. | 40° C. | 800 nm | yes | 9.0 μm | 160-180° C. | yes |
| Example 2 | | | | | | | | | | | |
| Comparative | THF | SP0 | 1 | 5 | 45° C. | 30° C. | 900 nm | yes | 9.3 μm | 170-180° C. | yes |
| Example 3 | | 160 | | | | | | | | | |
| Comparative | THF | H476 | 1 | 5 | 20° C. | 30° C. | 700 nm | yes | 8.9 μm | 170-180° C. | yes |
| Example 4 | | | | | | | | | | | |

The details of the waxes shown in Table 1 are as follows:

H476: produced by NOF COPORATION, ester wax, melting point: 63° C., dissolution temperature In MEK: 40° C., dissolution temperature in THF: 25° C.

WEP3: produced by NOF COPORATION, ester wax, melting point: 73° C., dissolution temperature in MEK: 50° C.

WEP5: produced by NOF COPORATION, ester wax, melting point: 84° C., dissolution temperature in MEK: 57° C.

HNP-9: produced by Nippon Seiro Co., Ltd., paraffin wax, melting point: 75° C., dissolution temperature in MEK: 57° C., dissolution temperature in THF: 35° C.

SPO160: produced by Nippon Seiro Co., Ltd., paraffin wax, melting point: 71° C., dissolution temperature in MEK: 55° C., dissolution temperature in THF: 32° C.

The embodiments described above are illustrative and explanatory of the invention. The foregoing disclosure is not intended to be precisely followed to limit the present invention. In light of the foregoing description, various modifications and alterations may be made by embodying the invention. The embodiments are selected and described for explaining the essentials and practical application schemes of the present invention which allow those skilled in the art to utilize the present invention in various embodiments and various alterations suitable for anticipated specific use.

The scope of the present invention is to be defined by the appended claims and their equivalents.

What is claimed is:

1. A method for producing a toner, comprising the steps of:
preparing a resin solution by mixing a binder resin, a colorant and a wax into an organic solvent;
preparing an emulsion by heating the resin solution to a temperature of not less than a level allowing the wax to dissolve and less than a boiling point of the organic solvent while heating an aqueous medium to the temperature, and mixing the resin solution and the aqueous medium with each other; and
preparing a suspension by removing the organic solvent from the emulsion, and aggregating and fusing the suspension.

2. The method for producing a toner according to claim 1, wherein the binder resin is polyester resin having an anionic group.

3. The method for producing a toner according to claim 1, wherein the wax is ester wax and/or paraffin wax.

4. The method for producing a toner according to claim 1, wherein the aqueous medium is an aqueous alkaline solution.

5. The method for producing a toner according to claim 1, wherein the organic solvent is capable of compatibility by 5 to 100% in water of 25° C.

6. The method for producing a toner according to claim 1, wherein the organic solvent is methyl ethyl ketone and/or tetrahydrofuran.

7. A toner obtained by a method for producing a toner comprising the steps of:
preparing a resin solution by mixing a binder resin, a colorant and a wax into an organic solvent;
preparing an emulsion by heating the resin solution to a temperature of not less than a level allowing the wax to dissolve and less than a boiling point of the organic solvent while heating an aqueous medium to the temperature, and mixing the resin solution and the aqueous medium with each other; and
preparing a suspension by removing the organic solvent from the emulsion, and aggregating and fusing the suspension.
